(19) United States
(12) Patent Application Publication
(10) Pub. No.: US 2026/0070481 A1
(43) Pub. Date: Mar. 12, 2026

(54) RETRACTABLE PATIO SYSTEM OF A RECREATIONAL VEHICLE AND METHOD THEREOF

(71) Applicant: Forest River, Inc., Elkhart, IN (US)

(72) Inventors: Collin C. Spickler, Goodyear, AZ (US); Vernon J. Troyer, Shipshewana, IN (US); Anthony P. Neu, Lagrange, IN (US)

(21) Appl. No.: 19/322,867

(22) Filed: Sep. 9, 2025

Related U.S. Application Data
(60) Provisional application No. 63/692,901, filed on Sep. 10, 2024.

(51) Int. Cl. B60P 3/34; F16H 19/04

(52) U.S. Cl. CPC B60P 3/34; F16H 19/04

(57) ABSTRACT

A retractable patio assembly of a recreational vehicle includes a plurality of arm assemblies coupled to the frame of the recreational vehicle. Each of the plurality of arm assemblies includes a housing, a first arm portion, a second arm portion, and an actuator. A drive mechanism is operably coupled to at least one actuator to control movement of the at least one actuator between an extended position and a retracted position. A top support member is coupled to a top portion of each of the plurality of arm assemblies and includes a first a top support member portion coupled to the first arm portion and a second a top support member portion coupled to the second arm portion.

### RELATED APPLICATIONS

This application claims the benefit of U.S. Provisional Patent Application Ser. No. 63/692,901, filed Sep. 10, 2024, the disclosure of which is hereby incorporated by reference in its entirety.

### FIELD OF THE DISCLOSURE

The present disclosure relates to a patio system, and more particularly to a patio system of a recreational vehicle.

### BACKGROUND

Recreational vehicles such as fifth wheel travel trailers provide individuals with spacious, comfortable and transportable lodging. In particular, a conventional recreational vehicle, e.g., a travel trailer, includes a housing member having a multi-level interior living space formed therein, a multi-level chassis adapted to support the housing member, and a carriage member having a plurality of wheels interposed between the chassis and a supporting surface so as to enable the trailer to travel on the supporting surface. Furthermore, in some examples, the conventional recreational vehicle is adapted to detachably mount to a towing vehicle so that a front end of the trailer extends beyond the load bearing rear wheels of the towing vehicle so as to enable the towing vehicle to essentially act as a fifth wheel.

Some conventional recreational vehicles are currently available with lengths as great as forty-five feet (and possibly longer) and pop-out sections that provide the housing member with increased width, their interior living spaces are able to resemble that of a nicely appointed home. For example, a fifth wheel travel trailer can include a large kitchen, a large bathroom, a large bedroom, and a large living area. Moreover, these trailers typically include multiple water storage tanks for supplying hot and cold water as well as for storing wastewater, wiring for distributing electrical power and a central heating/ventilation/air conditioning (HVAC) system for providing desirable environmental conditions within the interior living space.

### SUMMARY

In one implementation of the present disclosure, a retractable patio assembly configured to being coupled to a frame of a recreational vehicle includes a plurality of arm assemblies configured to being coupled to the frame, each of the plurality of arm assemblies comprising a housing, a first arm portion, a second arm portion, and an actuator; at least one drive mechanism operably coupled to at least one actuator, the at least one drive mechanism controllably moving the at least one actuator between an extended position and a retracted position; a top support member coupled to a top portion of each of the plurality of arm assemblies, the a top support member comprising a first a top support member portion coupled to the first arm portion and a second a top support member portion coupled to the second arm portion; wherein, in the retracted position, each of the plurality of arm assemblies is disposed in a collapsed position; wherein, in the extended position, each of the plurality of arm assemblies is configured to being extended relative to the frame such that the first a top support member portion and second a top support member portion are generally planarly aligned with one another.

In one example of this implementation, the first arm portion of each of the plurality of arm assemblies is pivotally coupled to the second arm portion thereof. In a second example, the plurality of arm assemblies includes a first arm assembly and a second arm assembly, the at least one drive mechanism being directly operably coupled to the actuator of first arm assembly; wherein, the actuator of the second arm assembly is operably coupled to the at least one drive mechanism via a line shaft. In a third example, only one actuator of the plurality of arm assemblies is directly coupled to the at least one drive mechanism. In a fourth example, each arm assembly of the plurality of arm assemblies includes a stationary portion and a movable portion, the first arm portion being pivotally coupled to the stationary portion.

In a fifth example, each arm assembly includes a frame mounting bracket configured to being coupled to the frame and the at least one drive mechanism. In a sixth example, a rack and pinion drive mechanism is operably coupled to the movable portion, the rack and pinion drive mechanism including a pinion gear, at least one drive shaft, and at least one guide wheel. In a seventh example, a support arm bracket is operably coupled between the second arm portion and the movable portion, the support arm bracket being pivotally coupled to the movable portion to accommodate a pivotal movement of the second arm portion relative to the first arm portion.

In another implementation of the present disclosure, a control system for controlling a patio assembly of a recreational vehicle includes a controller having a memory and a processor; at least one user control disposed in communication with the controller; at least one drive mechanism operably controlled by the controller; a first actuator operably controlled by the at least one drive mechanism, the first actuator being controlled to move between a first retracted position and a first extended position; a second actuator operably controlled between a second retracted position and a second extended position; and a line shaft operably coupled between the second actuator and either the first actuator or the at least one drive mechanism, the line shaft operably moving the second actuator between the second retracted position and the second extended position; wherein, the patio assembly includes a plurality of arm assemblies coupled to the first and second actuators, the patio assembly disposed in a deployed configuration when the first actuator is in the first extended position and the second actuator is in the second extended position.

In a first example of the implementation, the patio assembly is disposed in a transport configuration when the first actuator is in the first retracted position and the second actuator is in the second retracted position. In a second example, the patio assembly is movable between the deployed configuration and the transport configuration when the controller receives a signal from the at least one user control. In a third example, when the controller receives the signal from the at least one user control, the controller is configured to engage the at least one drive mechanism to actuate the first actuator between the first retracted position and the first extended position and the second actuator between the second retracted position and the second extended position.

In another example, a sensor is operably coupled to the controller, the sensor configured to detect if the patio assembly is in the deployed configuration or the transport configuration, wherein the sensor communicates to the controller if the patio assembly is in the deployed configuration or the transport configuration. In yet another example, the controller includes a vehicle controller and a patio assembly controller, the vehicle controller disposed in communication with the patio assembly controller.

In a further implementation of the present disclosure, a recreational vehicle includes a chassis having a front end, a rear end, a first side, and a second side; a first side wall coupled to the chassis along the first side, the first side wall defining an opening; a patio assembly coupled to the first side of the chassis, the patio assembly movable between a deployed configuration and a transport configuration, wherein the patio assembly includes a plurality of arm assemblies configured to being coupled to the frame, each of the plurality of arm assemblies including a housing, a first arm portion, a second arm portion, and an actuator; at least one drive mechanism operably coupled to at least one actuator, the at least one drive mechanism controllably moving the at least one actuator between an extended position and a retracted position; a top support member coupled to a top portion of each of the plurality of arm assemblies, the top support member having a first top support member portion coupled to the first arm portion and a second top support member portion coupled to the second arm portion; wherein, in the retracted position, each of the plurality of arm assemblies is disposed in a collapsed position; wherein, in the extended position, each of the plurality of arm assemblies is configured to being extended relative to the frame such that the first a top support member portion and second a top support member portion are generally planarly aligned with one another.

In one example of this implementation, in the transport configuration, the patio assembly is collapsed in the opening. In a second example, a wall assembly is coupled to the first side wall, the wall assembly including a first side member, a second side member and a top member, wherein the first side wall is aligned in a first plane and the wall assembly is aligned in a second plane, the first plane being parallel to and offset outwardly from the second plane. In a third example, the wall assembly is located about a periphery of the opening formed in the first side wall, the patio assembly being collapsed in the transport configuration in a gap formed between the first side wall and the wall assembly.

In another example, the patio assembly is disposed in contact with the wall assembly in the transport configuration. In a further example, the wall assembly includes an intermediate member located between the first side member and the second side member, the intermediate member located within the opening.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of a conventional multi-level fifth wheel travel trailer;

FIG. 2 is another side view of a conventional multi-level fifth wheel travel trailer;

FIG. 3A is a side view of a drop frame or chassis of a fifth wheel travel trailer;

FIG. 3B is a side view of a straight frame or chassis of a fifth wheel travel trailer;

FIG. 4 is an example implementation of an actuation support system of a retractable patio system for a recreational vehicle;

FIG. 5 is an example implementation of an arm assembly of the actuation support system of FIG. 4;

FIG. 6 is a side view of the example implementation of the arm assembly of FIG. 5;

FIG. 7 is a rear view of the example implementation of the arm assembly of FIG. 5;

FIG. 8 is a bottom view of the example implementation of the arm assembly of FIG. 5;

FIG. 9 is a top view of an example implementation of a top member of a retractable patio system;

FIG. 10 is a bottom view of the example implementation of the top member;

FIG. 11 is a schematic of a control system for controlling the actuation of the patio system of a recreational vehicle; and

FIG. 12 is a perspective view of one implementation of a portion of a frame of a recreational vehicle.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

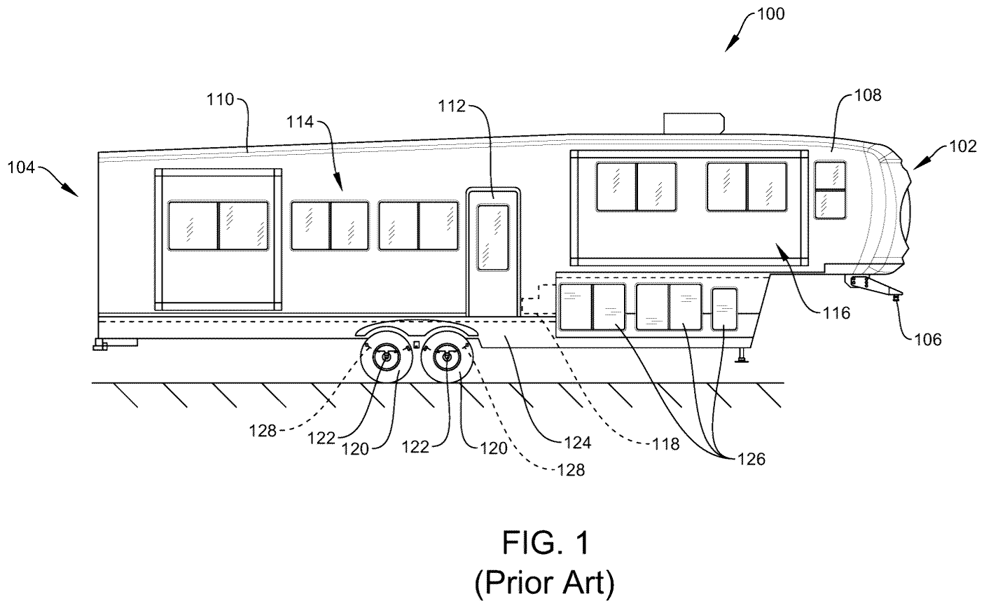

Conventional fifth wheel travel trailers generally include different living spaces separated from one another by a set of stairs. For example, a main living area may be located on a main level of the trailer, whereas the bedroom and bathroom are located on an upper level that requires a person to ascend steps to reach. An example of this is shown in FIG. 1.

In FIG. 1, a conventional multi-level fifth wheel travel trailer 100 is shown having a front 102 and a rear 104. A hitch 106 may be located at the front 102 of the trailer 100 for releasably coupling to a towing vehicle or machine (not shown). A fifth wheel travel trailer such as the one embodied in FIG. 1 includes a hitch that engages with a U-shaped coupling component on a towing vehicle or machine. With a truck, the coupling component may be mounted in a bed area of the truck at a location forward of the rear axle. Fifth wheel hitches can provide better handling and maneuverability during transport than a trailer that couples to a coupler mounted to a rear bumper of a towing vehicle.

The trailer 100 comprises a body 108 that defines a sloping roof 110 as shown in FIG. 1. The roof may slope rearward so that rain, snow and other water flows off of the roof 110 towards the rear 104. The body 108 may be supported by a chassis or drop frame (not shown), which is supported by one or more wheels 120 coupled thereto. Each wheel 120 is configured along an axle 122. The body 108 may include skirting 124, as shown in FIG. 1. A leaf spring 128, which forms part of a suspension of the travel trailer 100, is also shown.

The trailer 100 also includes a door 112 to gain access to an interior of the trailer 100. Although not shown, a set of steps are provided at the door 112. Once inside, the conventional trailer 100 includes a first living area 114 and a second living area 116. In the example of FIG. 1, the first living area 114 may include a kitchen, table, chairs, sofa, and entertainment options, whereas the second living area 116 may include a bedroom, closet and bathroom. A second set of steps 118 is located between the two living areas to provide access therebetween.

In FIG. 1, the trailer 100 is shown including a plurality of storage doors 126. Each storage door 126 may provide access to an individual storage compartment.

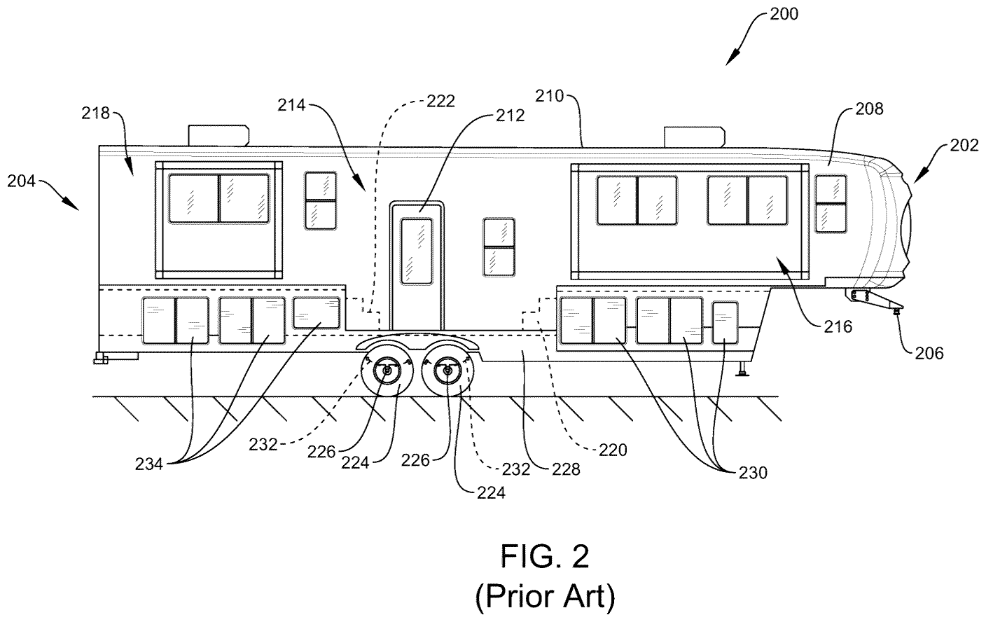

In FIG. 2, another conventional multi-level fifth wheel travel trailer 200 is shown. The trailer 200 includes a front 202 and a rear 204, with a hitch 206 for coupling to a towing vehicle (not shown) located towards the front 202. The trailer 200 includes a body 208 supported by a chassis or drop frame (not shown). The chassis or drop frame may be supported by one or more wheels 224 located along an axle 226. The body 208 includes a roof 210 with a door 212 for providing access to an interior thereof. Skirting 228 and the like may be provided along the lower edges of the body 208 as shown. A leaf spring 232 may form part of a suspension assembly for the travel trailer 200.

The interior of the fifth wheel travel trailer 200 may include a first living area 214 immediately accessible when entering through the door 212. Although not shown, a set of steps may be provided for entering and exiting the interior of the trailer 200.

The trailer 200 may include a second living area 216 and a third living area 218, each of which is separated by the first living area 214. The second living area 216 may be located towards the front 202 and the third living area 218 may be located towards the rear 204. In each case, both living areas are located at a different level from the first living area 214. For instance, a first set of steps 220 provides access between the first living area 214 and the second living area 216, while a second set of steps 222 provides access between the first living area 214 and the third living area 218.

The travel trailer 200 of FIG. 2 also includes a first set of storage doors 230 for accessing individual storage compartments at the front 202 of the trailer. Moreover, the trailer 200 includes a second set of storage doors 234 for accessing individual storage compartments at the rear 204 of the trailer 200. The storage compartments found in the travel trailer 200 of FIG. 2 can be separated from one other by walls or partitions (not shown). The same is true of the multi-level fifth wheel travel trailer 100 of FIG. 1.

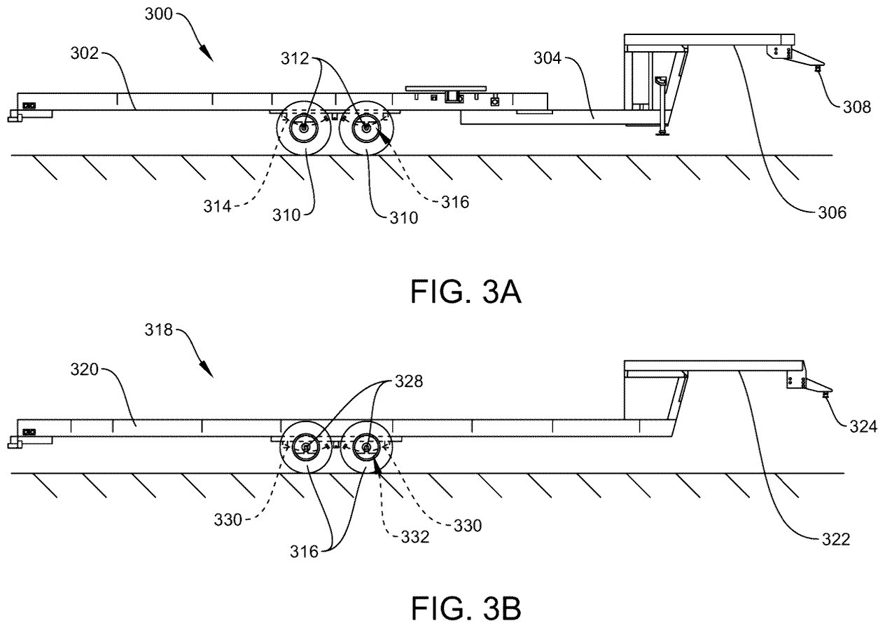

The trailers of FIGS. 1 and 2 include a conventional drop frame or chassis. An example of this is illustrated in FIG. 3A. Here, a drop frame assembly 300 includes a rear frame portion 302, a drop frame portion 304, and a front frame portion 306. The drop frame assembly 300 includes a hitch 308 at a front end thereof and one or more wheels 310 coupled thereto. The wheels 310 are located along an axle 312 of the trailer, and a leaf spring 314 may form part of a suspension assembly of the trailer. FIG. 3A shows the leaf spring 314 located above the axle 312 to form an “overslung” axle 316.

As described above and shown in FIGS. 1 and 2, conventional multi-level fifth wheel travel trailers include one or more sets of steps to reach different living areas within the interior of the trailer. This results in an end user having to traverse a lot of steps throughout a day when moving about the interior of the trailer. This can be particularly difficult for those with limited mobility. Moreover, the living areas that are elevated often include less headroom and thus can be more difficult to move about. The change in elevation between living areas can also impact the amount of storage provided in a multi-level fifth wheel travel trailer, and even those with multiple storage compartments can lose storage space. For example, a drop frame such as the one depicted in FIG. 3A can create a taller trunk which requires a user to stack items on top of one another to utilize the upper portion of the taller space. Further, it can be difficult to fit larger items in the provided storage space. Thus, there is a need for a single-level fifth wheel travel trailer that does not require steps to reach different living areas inside the trailer. It is further desirable to provide as much storage as possible while also creating additional headroom at the front and rear of the trailer.

To partly achieve the foregoing, the drop frame assembly 300 of FIG. 3A can be replaced with a lighter straight frame assembly 318 shown in FIG. 3B. As shown, the straight frame assembly 318 may include a substantially straight frame 320 without the drop portion found in the implementation of FIG. 3A. The assembly 318 includes a front frame portion 322 raised above the straight frame 320 at a front end thereof. The front frame portion 322 may include a hitch 324 for coupling to a towing vehicle. The frame assembly 318 may be supported by one or more wheels 326 which are arranged along an axle 328. A leaf spring 330 may form part of a suspension assembly, but the leaf spring 330 may be located below the axle 328 to form an “underslung” axle 332. In this implementation, the “underslung” axle 332 may provide better traction due to a lowered center of gravity of the trailer.

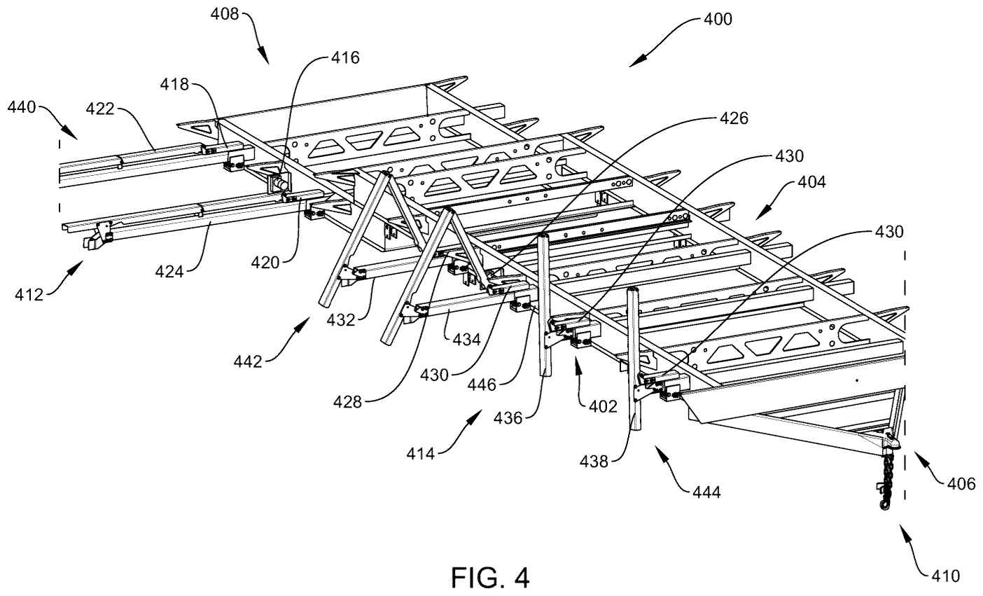

Referring to FIG. 4, a recreational trailer such as a travel trailer, fifth wheel, etc. is partially illustrated having an extendible patio system 400. The recreational trailer includes a frame or chassis 404 having a front end 410 and a rear end 408. The chassis 404 may be similar to the drop frame assembly 300 of FIG. 3A or the straight frame assembly 318 of FIG. 3B. The recreational trailer may include a hitch assembly 406 for being removably coupled to a towing vehicle.

The patio system 400 of FIG. 4 may include a front patio system 414 and a rear patio system 412. The front patio system 414 may be disposed towards the front end 410 of the recreational trailer, whereas the rear patio system 412 may be disposed towards the rear end 408 thereof.

The patio system 400 may include an actuation support assembly 402. The actuation support assembly 402 may include a first actuation support assembly for operably controlling the rear patio system 412 and a second actuation support assembly for operably controlling the front patio system 414. In one implementation, the actuator support assembly 402 includes a drive motor, a drive actuator, and at least one non-drive actuator. In FIG. 4, the actuator support assembly 402 of the rear patio system 412 includes a first drive motor 416. The first drive motor 416 may be an electric motor, a hydraulic motor, or any other known type of motor. The first drive motor 416 operably drives a first drive actuator 418. The first drive actuator 418 controllably moves a first arm assembly 422 between a deployed or extended position and a retracted position. In FIG. 4, the first arm assembly 422 is shown in the deployed or fully deployed/extended position. A second arm assembly 424 may also be operably controlled by a first non-drive actuator 420. A line shaft (not shown) may be operably driven by the first drive motor 416, and the line shaft operably controls movement of the first non-drive actuator 420. In FIG. 4, the rear patio system 412 is shown in the fully deployed or extended position 440.

The front patio system 414 also includes at least one actuation support assembly 402. The actuation support assembly 402 includes a second drive motor 426 for operably driving a second drive actuator 428. The second drive motor 426 may be an electric motor, a hydraulic motor, or any other known type of motor. The second drive actuator 428 controllably moves a first arm assembly 432 between a deployed or extended position and a retracted position. In FIG. 4, the first arm assembly 432 is shown in a partially deployed or retracted position 442, i.e., between a fully deployed/extended position and a fully retracted position. A second arm assembly 434 may also be operably controlled by a first of a plurality of non-drive actuators 430. A non-drive actuator refers to an actuator that is not directly coupled to a drive mechanism such as a drive motor but instead receives power via another structural component. For example, a line shaft 446 may be operably driven by the second drive motor 426 and operably controls movement of each of the plurality of non-drive actuators 430. In one implementation, the plurality of non-drive actuators may operably control movement of the second arm assembly 434, a third arm assembly 436, and a fourth arm assembly 438.

In FIG. 4, the first arm assembly 432 and the second arm assembly 434 are shown in the partially deployed position or partially retracted position 442. The third arm assembly 436 and the fourth arm assembly 438 are shown in the fully retracted position 444. The fully retracted position 444 may also be referred to as a travel or transport position.

As shown in FIG. 4, the actuation support assemblies 402 are operably coupled to the chassis 404 of the recreational trailer. In this manner, the front and rear patio assemblies are operably coupled to the chassis 404. In the fully retracted position 444, the front and rear patio assemblies are in a folded configuration located adjacent to a side wall of the recreational trailer. In other implementations, the front and/or rear patio assemblies may be retracted below or within a cassette-like opening formed in the chassis 404. When deployed, the front and rear patio assemblies extend outwardly away from the recreational trailer to form a surface located above an underlying ground surface upon which a user may set chairs, a grill, table, umbrella, or use the space in any desirable manner.

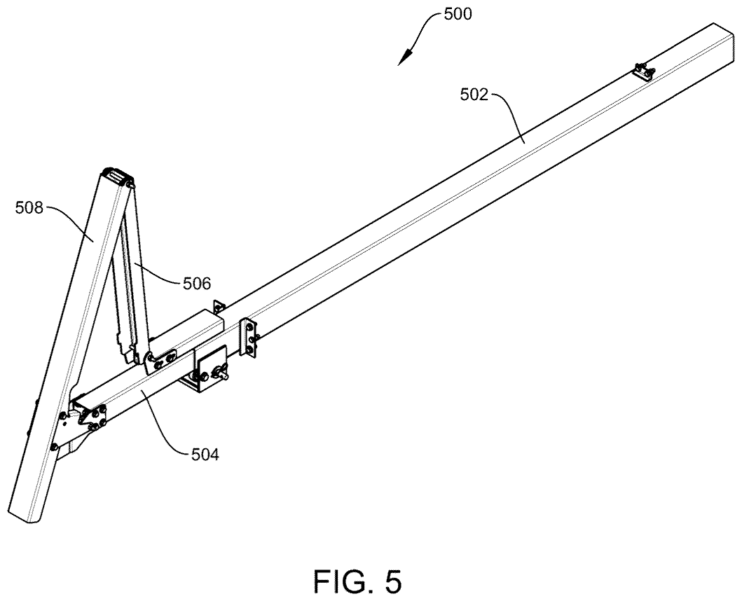

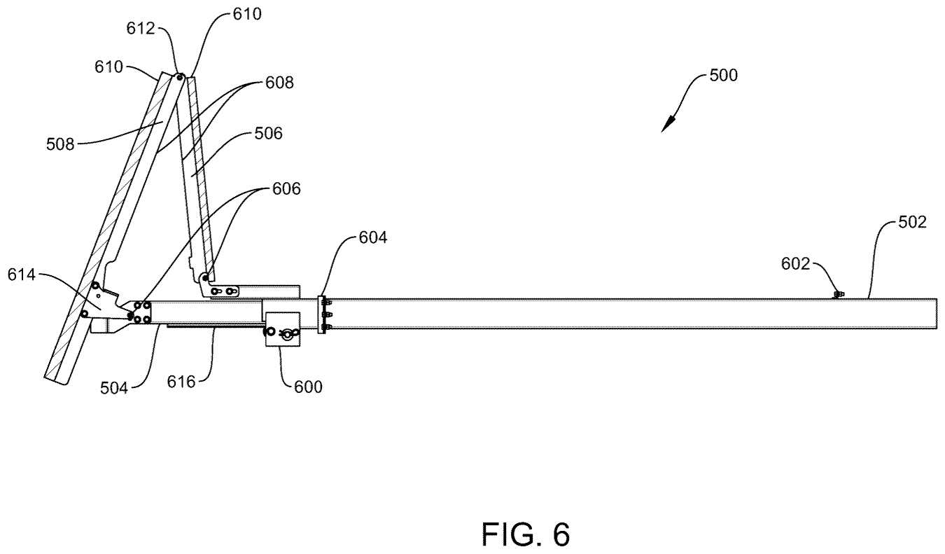

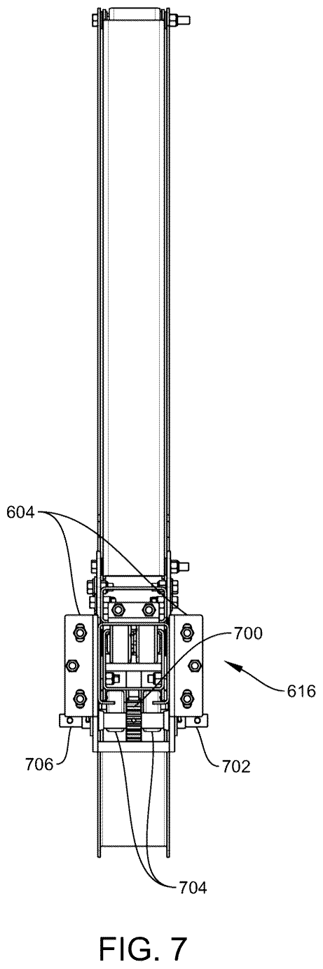

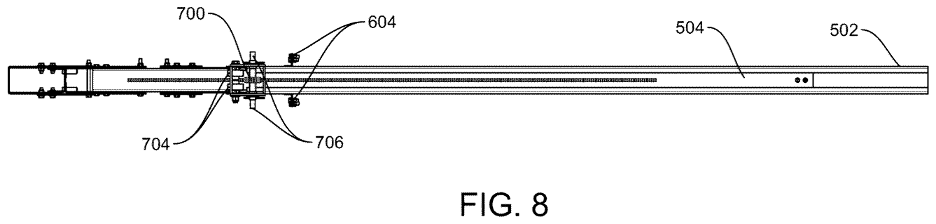

Referring to FIGS. 5-8, an example implementation of an arm assembly 500 is shown. In FIG. 5, the arm assembly 500 may include a first portion formed as a stationary housing 502 and a second, movable portion formed as a movable or travelling body 504. A first arm portion 506 and a second arm portion 508 may be pivotally coupled to one another. The first arm portion 506 may be pivotally coupled at one end to the housing 502 and at an opposite end to the second arm portion 508. The second arm portion 508 may be coupled at one end to the first arm portion 506 and at an opposite end thereof to the movable body 504. As shown best in FIG. 6, a decking material or top support member 610 may be coupled to the first and second arm portions 506, 508. In some implementations, mechanical fasteners may be used for coupling the top support member 610 to the respective arm portion. In other implementations, the top support member 610 may be welded, adhered, or coupled in an alternative manner to the respective arm portion.

Referring to FIGS. 6-8, the arm assembly 500 includes a frame mounting bracket 602 coupled to the stationary housing 502. The frame mounting bracket 602 is configured to be coupled to a chassis of the recreational trailer. Other components such as a drive motor may be coupled to the bracket 602. Another frame mounting bracket 604 may be coupled between the movable body 504 and the housing 502.

As shown in FIG. 6, a plurality of pivot points or locations 606 are provided. For example, the first arm portion 506 may be pivotally coupled to the frame mounting bracket 604 at a pivot location 606. Likewise, the second arm portion 508 may be pivotally coupled to a pivoting support arm bracket 614 at another pivot location 606. Lateral support and securement arm 608 is provided for coupling the deck material or top support member 610 to each of the first and second arm portions 506, 508. An additional pivot location 612 may be located at the coupling of the first and second arm portions 506, 508 to one another.

The movement of the movable body 504 relative to the housing 502 may be executed via a rack and pinion drive 616. The rack and pinion drive 616 includes a pinion gear 700, a first drive shaft 702, a second drive shaft 706, and one or more guide wheels 704. In other implementations, the rack and pinion drive 616 may be replaced by an actuator or other known movable mechanism.

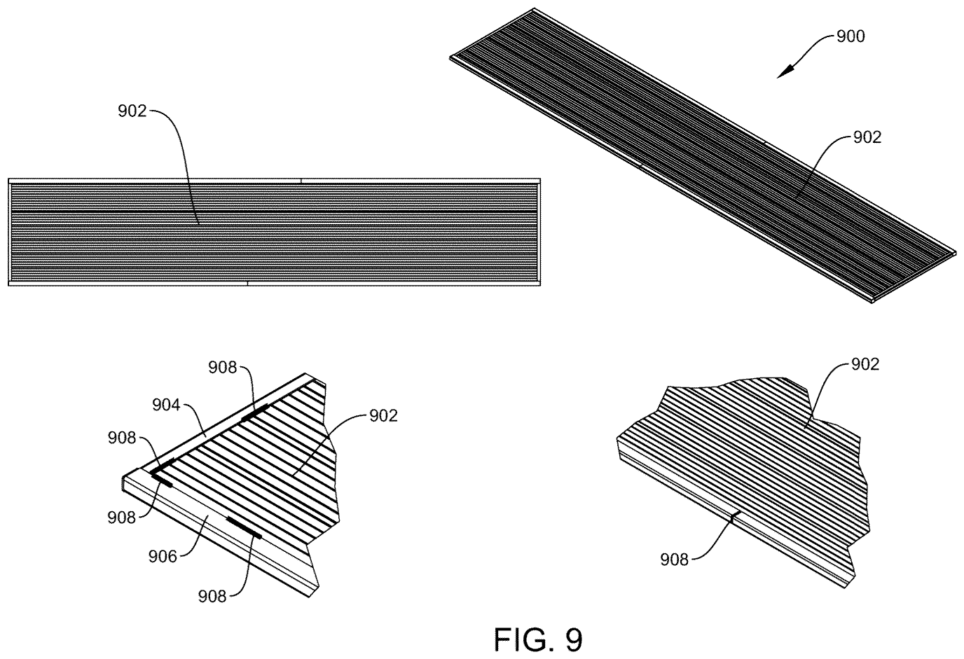

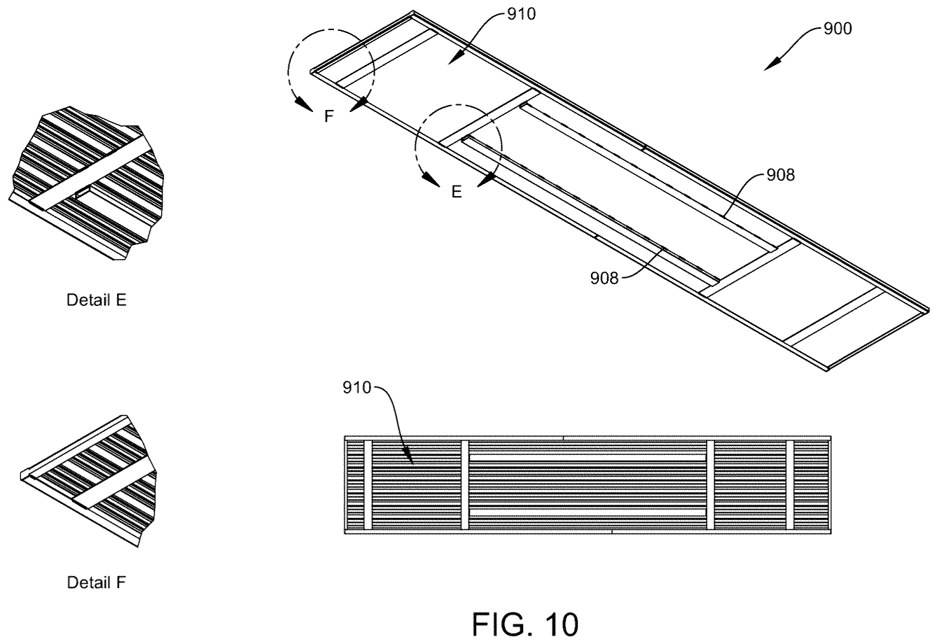

Referring to FIGS. 9 and 10 of the present disclosure, a decking or top support member 900 is shown. In FIG. 9, a top surface 902 of the top support member 900 is shown. The top support member 900 may include a sheet of material with a first outer trim or framing 904 and a second outer trim or framing 906 formed about a periphery of the material. One or more welds 908 or fasteners may be used for coupling the material and framing to one another. The top support member 900 may be adjacently aligned with one or more top support members 900 to form a top surface of the patio system.

In FIG. 10, a bottom surface 910 of the top support member 900 is shown.

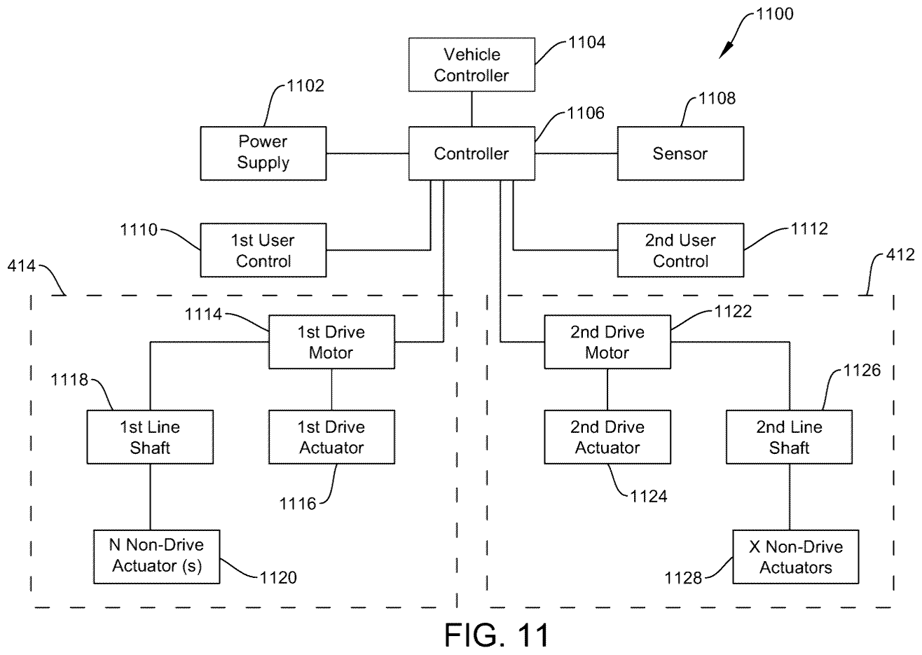

Referring to FIG. 11, one implementation of a control system 1100 is shown for controlling movement of the front patio assembly 414 and rear patio assembly 412. The control system 1100 may include a power supply 1102 such as a battery. In one example, the power supply 1102 may be a battery from a towing vehicle. In another example, the power supply 1102 may be a battery separate from the vehicle battery. In yet another example, the power supply 1102 may be a solar panel. In a further example, the power supply 1102 may be an electrical outlet. In yet a further example, the power supply 1102 may be an electric generator. Other known types of power supplies may be used for purposes of the present disclosure.

The power supply 1102 is configured to provide power to at least a controller 1106. The controller 1106 may be configured to operably control movement of the front and rear patio assemblies. The controller 1106 may be in communication with a vehicle controller 1104 of a towing vehicle in some implementations. In several implementations, a sensor or plurality of sensors 1108 may be in communication with the controller 1106. The sensor 1108 may detect if the recreational trailer or vehicle is moving or stationary, or if there is an object present in a possible path of movement of either the front or rear patio assembly. The sensor 1108 may detect a position of a drive motor, drive actuator, arm assembly, etc. The sensor 1108 may be configured to detect a position of the front and/or rear patio assembly. In any event, the sensor 1108 may send signals to the controller 1106 based on a detection.

In some implementations, the sensor 1108 may include more than one sensor. In one implementation, one sensor 1108 may detect a position of the front patio assembly 414 and a second sensor 1108 may detect a position of the rear patio assembly 412. In some implementations, the sensor 1108 may include a camera for providing visual detection of a surrounding area. The controller 1106 may include a processor capable of receiving and analyzing the signals from the sensor 1108. Moreover, the controller 1106 may be configured to transmit the images or video detection from the camera to a screen (e.g., dashboard) in the towing vehicle or recreational trailer. In other implementations, the control system 1100 may not include a controller 1106.

The control system 1100 may include a first user control 1110 and a second user control 1112. In one implementation, the first user control 1110 may be located internally of the recreational trailer and the second user control 1112 may be located externally. In another implementation, a user may trigger the first user control 1110 as a switch to enable electrical power from the power supply 1102 to be supplied to a second user control 1112 or an actuator support assembly of the front or rear patio assemblies. Upon actuating the first user control 1110, the second user control 1112 may be actuated to control movement of the front and/or rear patio assemblies between their retracted and deployed positions. The second user control 1112 may include a switch, knob, lever or the like for controlling the front and rear patio assemblies independently of one another. The second user control 1112 may include one control for controlling the front patio assembly 414 and a second control for controlling the rear patio assembly 412. In this arrangement, the front and rear patio assemblies may be controlled independently of one another. In other implementations, a single user control may control the front and rear patio assemblies in unison, synchronously, or concomitantly with one another.

A first drive motor 1114 may be used for controlling movement of the front patio assembly 414. The first drive motor 1114 receives power from the power supply 1102 and actuates a first drive actuator 1116 and a first line shaft 1118. The first line shaft 1118 thereby controls actuation of one or any number, N, of first non-drive actuators 1120. For purposes of this disclosure, a non-drive actuator is an actuator that is not directly coupled to the drive motor. The non-drive actuator receives power or actuation from a secondary source such as the line shaft.

A second drive motor 1122 may be used for controlling movement of the rear patio assembly 412. The second drive motor 1122 receives power from the power supply 1102 and actuates a second drive actuator 1124 and a second line shaft 1126. The second line shaft 1126 thereby controls movement of one or any number, X, of second non-drive actuators 1128.

In this manner, the front and rear patio assemblies are operably controlled between deployed and retracted positions.

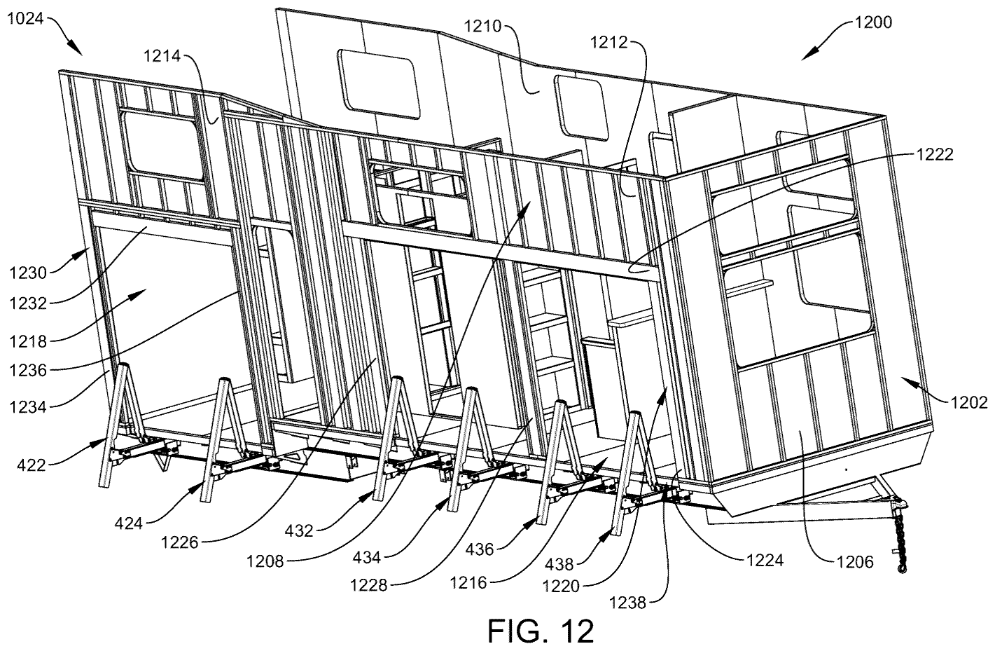

Referring to FIG. 12, another implementation of a recreational vehicle is shown including one or more retractable patio assemblies. In FIG. 12, a portion of a framework or frame 1200 of the vehicle is illustrated. The frame 1200 is shown having a front end 1202 and a rear end 1204. A hitch assembly may be coupled to the front end 1202 of the vehicle. The recreational vehicle may be a travel trailer, fifth wheel, motorhome, toy hauler, or any other type of recreational vehicle known in the art.

The frame 1200 may form a front wall 1206, a first side wall 1208, a second side wall 1210, and a bottom wall. Although not shown, the frame 1200 may also form a rear wall and a top wall. In the implementation of FIG. 12, the recreational vehicle may include a first or front patio assembly and a second or rear patio assembly. For example, the recreational vehicle may include the front patio system 414 and the rear patio system 412. In other implementations, the recreational vehicle may include only one retractable patio system or assembly. In yet other implementations, three or more retractable patio systems or assemblies may be provided. Moreover, while in FIG. 12 the retractable patio assemblies are shown on a first side of the recreational vehicle, in other implementations one or more patio assemblies may be provided on a second or opposite side thereof.

The first side wall 1208 may be generally planar between the front end 1202 and the rear end 1204. In other implementations, the first side wall 1208 may not be generally planar but have offsets or extended portions between the front end 1202 and rear end 1204. For example, in FIG. 12, the first side wall 1208 may include a first wall portion 1212 and a second wall portion 1214. In some implementations, the first wall portion 1212 and second wall portion 1214 may be generally aligned and planar with one another (e.g., disposed in the same plane). In other implementations, the first wall portion 1212 may be offset from the second wall portion 1214 such that the first wall portion 1212 lies in a first plane and the second wall portion 1214 lies in a different plane. The two wall portions may be parallel but offset from one another.

To accommodate the different patio assemblies, the first side wall 1208 may include a first opening 1216 and a second opening 1218. The first opening 1216 may be sized based on a height and width of the first or front patio assembly, and the second opening 1218 may be sized based on a height and width of the second or rear patio assembly.

The frame 1200 of the recreational vehicle may include a first wall assembly 1220 for accommodating the first or front patio assembly. The first wall assembly 1220 may include a top member 1222, a first side member 1224, a second side member 1226, and an intermediate member 1228. In one implementation, the first wall assembly 1220 may be formed of a material similar to that of the first side wall 1208. For example, the first wall assembly 1220 may be formed of wood, steel, plastic, or any other material. The first wall assembly 1220 is structured to be offset inwardly with respect to the first wall portion 1212. As shown in FIG. 12, the first wall assembly 1220 may be located in an inset location 1238 relative to the first wall portion 1212. In some implementations, the first wall assembly 1220 may be inset by a few inches. In other implementations, the first wall assembly 1220 may be inset by a foot or more. In any event, the first wall assembly 1220 is located generally in a plane that is parallel but offset relative to the plane in which the first wall portion 1212 is located. By locating the first wall assembly 1220 inwardly of the first wall portion 1212, the first or front patio assembly may be retracted fully into proximate contact with the first wall assembly in the retracted position. In the retracted position, the first or front patio assembly may not protrude outwardly from the first side wall 1208 such that the recreational vehicle still meets all federal and state requirements. In other words, in the retracted position, the first or front patio assembly may be located partially within the space defined by the offset between the first wall portion 1212 and the first wall assembly 1220.

Similarly, the frame 1200 of the recreational vehicle may include a second wall assembly 1230 for accommodating the second or rear patio assembly. The second wall assembly 1230 may include a top member 1232, a first side member 1234, and a second side member 1236. In this implementation, the second wall assembly 1230 does not include an intermediate member as the second opening 1218 may be smaller in width than the first opening 1216. The second wall assembly 1230 is structured to be offset inwardly with respect to the second wall portion 1214. Similar to the first wall assembly 1220, the second wall assembly 1230 may be located in at an inset location relative to the second wall portion 1214. In some implementations, the second wall assembly 1230 may be inset by a few inches. In other implementations, the second wall assembly 1230 may be inset by a foot or more. In any event, the second wall assembly 1230 is located generally in a plane that is parallel but offset relative to the plane in which the second wall portion 1214 is located. By locating the second wall assembly 1230 inwardly of the second wall portion 1214, the second or rear patio assembly may be retracted fully into proximate contact with the second wall assembly 1230 in the retracted position. In the retracted position, the second or rear patio assembly may not protrude outwardly from the first side wall 1208. In other words, in the retracted position, the second or rear patio assembly may be located partially within the space defined by the offset between the second wall portion 1214 and the second wall assembly 1230.

While exemplary implementations incorporating the principles of the present disclosure have been disclosed hereinabove, the present disclosure is not limited to the disclosed implementations. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A retractable patio assembly configured to being coupled to a frame of a recreational vehicle, comprising:
a plurality of arm assemblies configured to being coupled to the frame, each of the plurality of arm assemblies comprising a housing, a first arm portion, a second arm portion, and an actuator;
at least one drive mechanism operably coupled to at least one actuator, the at least one drive mechanism controllably moving the at least one actuator between an extended position and a retracted position;
a top support member coupled to a top portion of each of the plurality of arm assemblies, the top support member comprising a first top support member portion coupled to the first arm portion and a second top support member portion coupled to the second arm portion;
wherein, in the retracted position, each of the plurality of arm assemblies is disposed in a collapsed position;
wherein, in the extended position, each of the plurality of arm assemblies is configured to being extended relative to the frame such that the first a top support member portion and second a top support member portion are generally planarly aligned with one another.

2. The retractable patio assembly of claim 1, wherein the first arm portion of each of the plurality of arm assemblies is pivotally coupled to the second arm portion thereof.

3. The retractable patio assembly of claim 1, wherein the plurality of arm assemblies comprises a first arm assembly and a second arm assembly, the at least one drive mechanism being directly operably coupled to the actuator of first arm assembly;
wherein, the actuator of the second arm assembly is operably coupled to the at least one drive mechanism via a line shaft.

4. The retractable patio assembly of claim 1, wherein only one actuator of the plurality of arm assemblies is directly coupled to the at least one drive mechanism.

5. The retractable patio assembly of claim 1, wherein each arm assembly of the plurality of arm assemblies comprises a stationary portion and a movable portion, the first arm portion being pivotally coupled to the stationary portion.

6. The retractable patio assembly of claim 5, wherein each arm assembly comprises a frame mounting bracket configured to being coupled to the frame and the at least one drive mechanism.

7. The retractable patio assembly of claim 5, further comprising a rack and pinion drive mechanism operably coupled to the movable portion, the rack and pinion drive mechanism including a pinion gear, at least one drive shaft, and at least one guide wheel.

8. The retractable patio assembly of claim 5, further comprising a support arm bracket operably coupled between the second arm portion and the movable portion, the support arm bracket being pivotally coupled to the movable portion to accommodate a pivotal movement of the second arm portion relative to the first arm portion.

9. A control system for controlling a patio assembly of a recreational vehicle, the control system comprising:
a controller comprising a memory and a processor;
at least one user control disposed in communication with the controller;
at least one drive mechanism operably controlled by the controller;
a first actuator operably controlled by the at least one drive mechanism, the first actuator being controlled to move between a first retracted position and a first extended position;
a second actuator operably controlled between a second retracted position and a second extended position; and
a line shaft operably coupled between the second actuator and either the first actuator or the at least one drive mechanism, the line shaft operably moving the second actuator between the second retracted position and the second extended position;
wherein, the patio assembly comprises a plurality of arm assemblies coupled to the first and second actuators, the patio assembly disposed in a deployed configuration when the first actuator is in the first extended position and the second actuator is in the second extended position.

10. The control system of claim 9, wherein the patio assembly is disposed in a transport configuration when the first actuator is in the first retracted position and the second actuator is in the second retracted position.

11. The control system of claim 10, wherein the patio assembly is movable between the deployed configuration and the transport configuration when the controller receives a signal from the at least one user control.

12. The control system of claim 11, wherein, when the controller receives the signal from the at least one user control, the controller is configured to engage the at least one drive mechanism to actuate the first actuator between the first retracted position and the first extended position and the second actuator between the second retracted position and the second extended position.

13. The control system of claim 9, further comprising a sensor operably coupled to the controller, the sensor configured to detect if the patio assembly is in the deployed configuration or the transport configuration, wherein the sensor communicates to the controller if the patio assembly is in the deployed configuration or the transport configuration.

14. The control system of claim 9, wherein the controller comprises a vehicle controller and a patio assembly controller, the vehicle controller disposed in communication with the patio assembly controller.

15. A recreational vehicle, comprising:
a chassis having a front end, a rear end, a first side, and a second side;
a first side wall coupled to the chassis along the first side, the first side wall defining an opening;
a patio assembly coupled to the first side of the chassis, the patio assembly movable between a deployed configuration and a transport configuration, wherein the patio assembly comprises:
a plurality of arm assemblies configured to being coupled to the frame, each of the plurality of arm assemblies comprising a housing, a first arm portion, a second arm portion, and an actuator;
at least one drive mechanism operably coupled to at least one actuator, the at least one drive mechanism controllably moving the at least one actuator between an extended position and a retracted position;
a top support member coupled to a top portion of each of the plurality of arm assemblies, the top support member comprising a first top support member portion coupled to the first arm portion and a second top support member portion coupled to the second arm portion;
wherein, in the retracted position, each of the plurality of arm assemblies is disposed in a collapsed position;
wherein, in the extended position, each of the plurality of arm assemblies is configured to being extended relative to the frame such that the first a top support member portion and second a top support member portion are generally planarly aligned with one another.

16. The recreational vehicle of claim 15, wherein, in the transport configuration, the patio assembly is collapsed in the opening.

17. The recreational vehicle of claim 15, further comprising a wall assembly coupled to the first side wall, the wall assembly comprising a first side member, a second side member and a top member, wherein the first side wall is aligned in a first plane and the wall assembly is aligned in a second plane, the first plane being parallel to and offset outwardly from the second plane.

18. The recreational vehicle of claim 17, wherein the wall assembly is located about a periphery of the opening formed in the first side wall, the patio assembly being collapsed in the transport configuration in a gap formed between the first side wall and the wall assembly.

19. The recreational vehicle of claim 17, wherein the patio assembly is disposed in contact with the wall assembly in the transport configuration.

20. The recreational vehicle of claim 17, wherein the wall assembly comprises an intermediate member located between the first side member and the second side member, the intermediate member located within the opening.
